(19) United States
(12) Patent Application Publication
(10) Pub. No.: US 2018/0256441 A1
(43) Pub. Date: Sep. 13, 2018

(54) MASSAGE DEVICE

(71) Applicant: Dakota Smith, Chicago, IL (US)

(72) Inventor: Dakota Smith, Chicago, IL (US)

(21) Appl. No.: 15/457,285

(22) Filed: Mar. 13, 2017

(51) Int. Cl. A61H 15/00

(52) U.S. Cl. CPC A61H 15/00; A61H 2015/0042; A61H 2201/1253; A61H 2205/12; A61H 2015/0064

(57) ABSTRACT

A massage device comprising a ball and a base with a single channel defined by a rim. The single channel contains a middle surface that has a concave arc shape along its length and a constant arc depth. The ball has a ball radius that is substantially equal to the constant arc depth. The ball is capable of being freely inserted into and freely removed from the single channel. When the ball surface makes contact with middle surface, the ball may roll in a longitudinal direction, while the concave arc shape limits the ball from rolling in a lateral direction.

### BACKGROUND

Plantar fasciitis is the tearing and inflammation of the plantar fascia, which is the ligament that attaches the heel bone to the toes. It is a leading cause of heel pain and is common among middle-aged persons, athletes, and soldiers. Symptoms of plantar fasciitis can range from slight aches in the morning to immobilizing pain.

Cold therapy can be used to treat plantar fasciitis. Cold therapy involves applying a cold surface to the area of the injury for a period of time, usually between 10 and 20 minutes. This helps to reduce inflammation and provides relief from pain.

Another method of treatment involves messaging the plantar fascia by pressing the sole of a foot on a rounded object on the floor and rolling the rounded object repeatedly in a back and forth motion. This causes pressure to be applied to the foot between the heel and toes, massaging the plantar fascia. However, the rounded object is difficult to control, and it may slip from between the foot and floor if too much pressure is applied.

In order to achieve a deep tissue massage using a rounded object on the floor, the user is forced to learn a new skill: controlling the rounded object with their foot. For certain individuals, learning this skill may prove time consuming and difficult. Accordingly, an easy to use device which provides the necessary control to obtain a deep tissue massage is desirable.

### SUMMARY

The present invention provides a user with more control over the direction the ball travels and allows the user to target specific areas for a deep massage.

In summary, the present invention comprises a ball and a base with a longitudinal axis and a single channel defined by a rim. The single channel is symmetrical along the longitudinal axis and has a proximal surface, a distal surface, and a middle surface. The middle surface extends a predetermined length between the proximal surface and the distal surface. A cross section of the middle surface has a concave arc shape along the entire predetermined length. The concave arc shape has a constant arc width and a constant arc depth. The ball has a ball surface and a ball radius. The ball radius is substantially equal to the constant arc depth. The ball is capable of being freely inserted into and freely removed from the single channel, and when the ball surface makes contact with middle surface, the ball may roll in a longitudinal direction, while the concave arc shape limits the ball from rolling in a lateral direction.

In some embodiments, the present invention further comprises a proximal rim portion abutting the proximal surface and a distal rim portion abutting the distal surface. The proximal rim portion and the distal rim portion each have a concave semi-circular shape and an open side. Each open side has a semi-circle width. The open side of the proximal rim portion, and the open side of the distal rim portion face towards the middle surface. The semi-circle width of the proximal rim portion and the semi-circle width of the distal rim portion is the same as the constant arc width. The proximal surface extends from the proximal rim portion in a curved concave manner towards a proximal common point located along the longitudinal axis at a proximalmost edge of the middle surface. The distal surface extends from the distal rim portion in a curved concave manner towards a distal common point along the longitudinal axis at a distalmost edge of the middle surface.

In other embodiments, the ball may be cooled to a therapeutic temperature, and the ball may be comprised of a material which retains the therapeutic temperature during use. In these embodiments, the benefits of cold therapy are combined with the benefits of a deep massage, allowing for more efficient treatment.

### BRIEF DESCRIPTION OF THE DRAWINGS

FIG. 1 is a top perspective view a one embodiment of the massage device which includes the base and ball.

FIG. 2 is a top view of the base of FIG. 1.

FIG. 3 is a lateral cross section of the base of FIG. 2 taken along line 3-3.

FIG. 4 is a perspective view of the base of FIG. 1.

FIG. 5 is a lateral cross section of the base and ball of FIG. 1 taken along line 5-5.

FIG. 6 is a longitudinal cross section of the base of FIG. 2 taken along line 6-6. The base contains a second embodiment of the ball. The ball is in contact with the distal surface of the single channel of the base.

FIG. 7 is a bottom perspective view of a second embodiment of the base.

FIG. 8 is an inverted lateral cross section of the base of FIG. 7 along line 8-8.

### DETAILED DESCRIPTION OF THE INVENTION

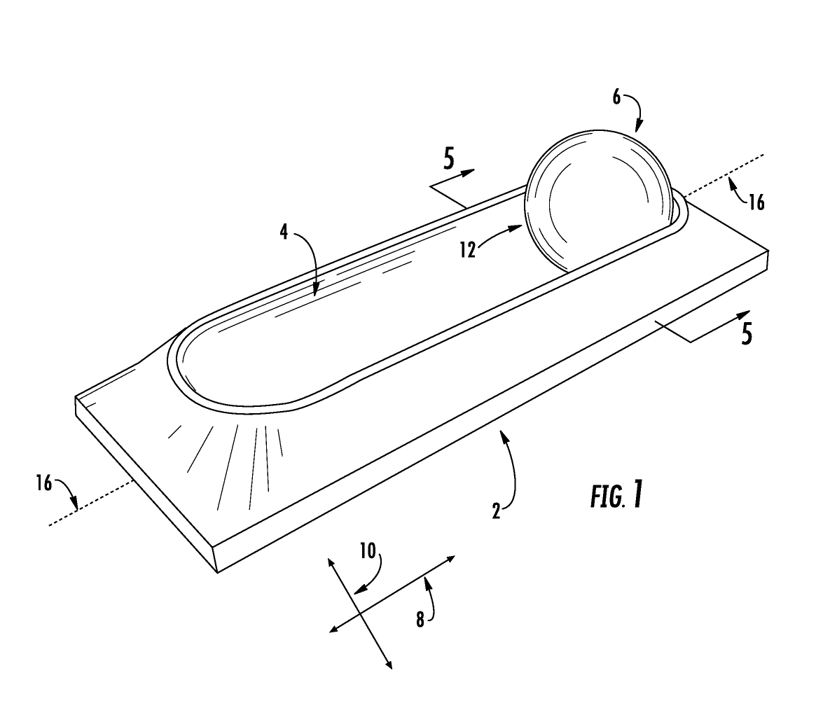

As shown in FIG. 1, a base 2 has a single channel 4. The singe channel 4 is wide enough to accommodate a ball 6. When the ball 6 is within the single channel 4, the shape of the single channel 4 allows the ball 6 to travel in a longitudinal direction 8 while limiting movement in the lateral direction 10.

The base 2 may be made of plastic, rubber, wood, metal or any other suitable material. If the base 2 is made of plastic, it may be manufactured by an injection molding process. The base 2 must be made of a material and construction that resists deformation when a user applies a force to the base 2 with his or her foot. If the material is not strong enough, the base 2 and the single channel 4 may become deformed, impairing the overall functionality of the device.

The ball 6 may be made of plastic, rubber, metal, glass, stone or any other suitable material. Similar to the material used to make the base 2, the ball 6 must be made of a material and construction that resists deformation when a user applies force to the ball 6. The ball 6 may be made of stone, such as granite or marble, which is porous. When the ball 6 is made from porous stone, the texture of the ball surface 12 increases friction between the foot and the ball 6, and the ball 6 and the single channel 4, helping to improve control and preventing the ball 6 from inadvertently sliding along the single channel 4 during use.

In the event the ball 6 is made of plastic, rubber, metal, or glass, the ball surface 12 may be treated to increase friction between the ball surface 12 and the foot, and the ball surface 12 and the single channel 4. For example, a treated ball surface 12 might be microscopically ridged or knurled.

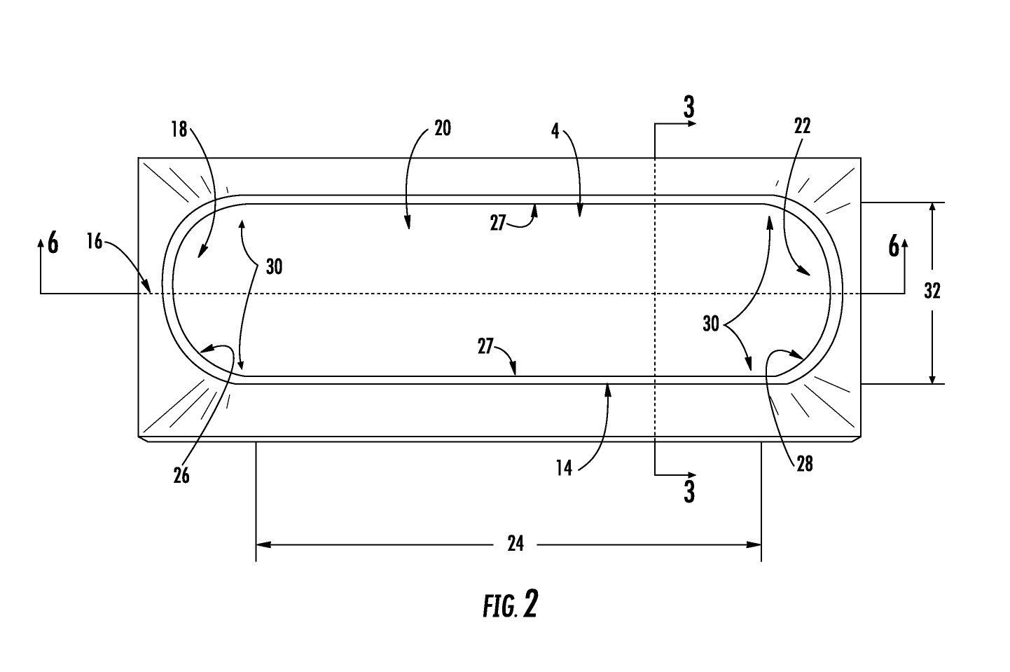

FIG. 2 shows a top view of the base 2 of FIG. 1. A rim 14 encircles the single channel 4. The single channel 4 is symmetrical along the longitudinal axis 16. The single channel 4 has a proximal surface 18, middle surface 20 and a distal surface 22. In this embodiment, the proximal surface 18 is the mirror image of the distal surface 22. For most uses of the device, the length of a user's foot will be orientated along the longitudinal axis 16. In these instances, the proximal surface 18 is closer to the heel of a user's foot than the distal surface 22. The middle surface 20 extends between the proximal surface 18 and the distal surface 22 for a predetermined length 24. Because the length and shape of the plantar fascia varies between individuals, the middle surface 20 may be of various predetermined lengths 24. Predetermined lengths 24 between 3″ and 12″ have been found effective. A predetermined length 24 of 7.5″ allows for suitable longitudinal motion to massage most feet.

The rim 14 has a proximal rim portion 26, middle rim portion 27, and a distal rim portion 28. The proximal rim portion 26 is the portion of the rim 14 abutting the proximal surface 18. The middle rim portion 27 is the portion of the rim 14 abutting the middle surface 20, and the distal rim portion 28 is a portion of the rim 14 abutting the distal surface 22. In the embodiment shown in FIG. 2, the proximal rim portion 26 and the distal rim portion 28 have a semi-circular shape with an open side 30 having a semi-circle width 32. The open side 30 of the semi-circular shape faces the middle surface 20, and the proximal rim portion 26 and the distal rim portion 28 each make contact with the middle rim portion 27.

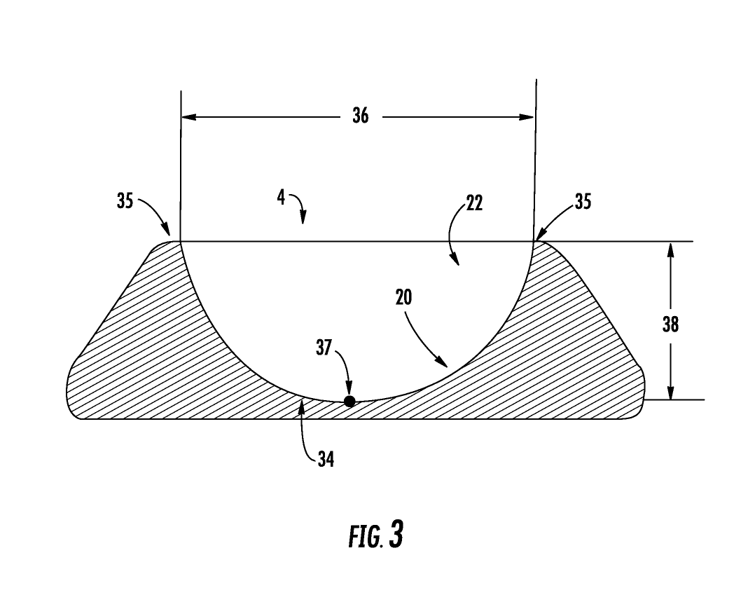

FIG. 3 is a lateral cross section of the base of FIG. 2 taken along line 3-3 with a view of the base 2 along the longitudinal axis 16 towards the distal surface 22. FIG. 3 shows a cross section of the base 2 along the middle surface 20 of the single channel 4. The middle surface 20 has a concave arc shape 34, which extends the entire predetermined length 24 of the middle surface 20 along the longitudinal axis 16. The concave arc shape 34 has a constant arc width 36 and a constant arc depth 38. If the base 2 is on a level surface, the constant arc depth 38 is the vertical distance between the point 35 where the concave arc shape 34 begins and the lowest point of the concave arc shape 37. Due to the longitudinal symmetry of the single channel 4, the lowest point of the concave arc shape 37 will be along the longitudinal axis 16. Because the constant arc width 36 and constant arc depth 38 are the same throughout the entire predetermined length 24, the middle surface 20 is continuous and uniform throughout. In the shown embodiment, the constant arc width 36 is the same as the semi-circle width 32 of the proximal rim portion 26 and distal rim portion 28, and the entire surface of the single channel 4 is continuous and uniform.

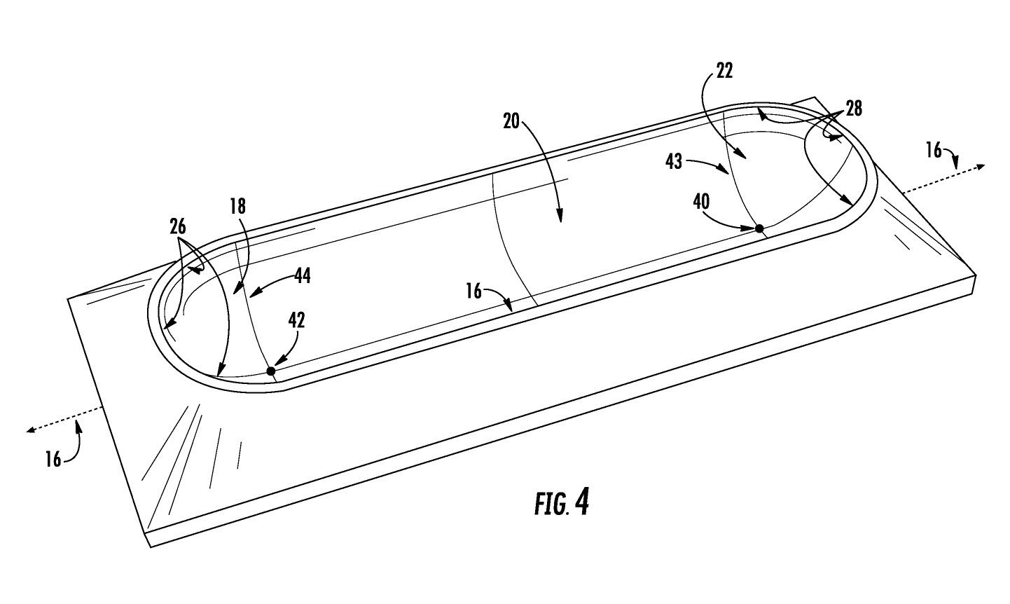

FIG. 4 is a perspective view of the base of FIG. 1 but with the ball removed. FIG. 4 shows the distal surface 22 extending from the distal rim portion 28. The distal rim portion 28 extends in a curved concave manner towards a distal common point 40. The distal common point 40 is located along the longitudinal axis 16 at a distalmost edge 43 of the middle surface 20. Likewise, the proximal surface 18 extends in a curved concave from the proximal rim portion 26 towards a proximal common point 42. Similar to the distal common point 40, the proximal common point 42 is located along the longitudinal axis 16 at a proximalmost edge 44 of the middle surface 20.

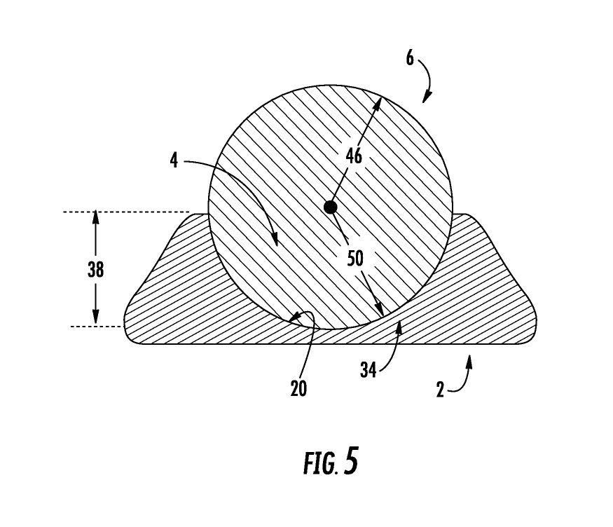

FIG. 5 is a lateral cross section of the base and ball of FIG. 1 taken along line 5-5 with a view along the longitudinal axis 16 towards the distal surface 22. Line 5-5 in FIG. 1 passes through the ball 6 at its diameter. FIG. 5 shows the ball 6 within the single channel 4 along the middle surface 20. The ball 6 has a ball radius 46 which is substantially equal to the constant arc depth 38, and the ball surface 12 is in contact with the middle surface 20. The constant arc depth 38 must be of a sufficient height to impede the ball 6 from escaping the single channel 4 if the user applies a lateral force during treatment. The lower the constant arc depth 38, the more likely a lateral force will allow the ball 6 to escape. In the embodiment shown in FIG. 5, the concave arc shape 34 is a circular arc with an arc radius 50, and the ball radius 46 is up to about the arc radius 50.

The constant arc depth 38 must also not be too great. While a greater constant arc depth 38 is more likely to prevent the ball 6 from escaping the single channel 4, a constant arc depth 38 that is too high may cause the sides of the middle surface 20 to extend vertically beyond the width of the ball 6. This may limit the portion of the ball surface 12 available to interact with the sole of the user's foot. In other words, not enough of the ball surface 12 will extend above the base 2 to allow the user to push the sole of his or her foot into the ball 6, thereby prohibiting a deep massage.

In light of the above, the ball radius 46 should be substantially equal to the constant arc depth 38. If the constant arc depth 38 is between 70% and 100% of the ball radius 46, a suitable amount of ball surface 12 will be exposed for a deep massage, and the ball 6 will be impeded from escaping the single channel 4 due to a lateral force.

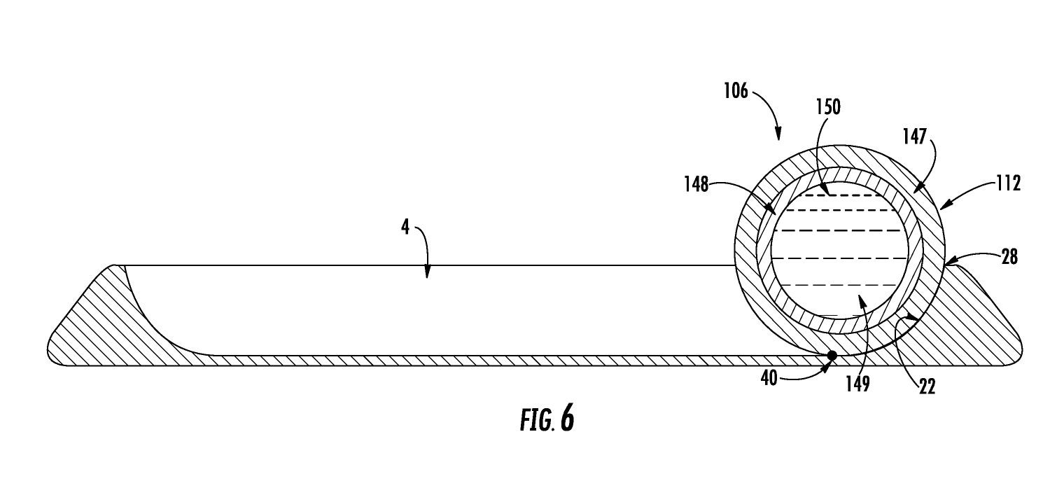

FIG. 6 is a longitudinal cross section of the base of FIG. 2 taken along line 6-6. FIG. 6 further includes a ball 106. Ball 106 represents a second embodiment of the ball of the present invention. The ball surface 112 of ball 106 is shown in contact with the distal surface 22. The ball 106 includes a shell 147 which surrounds a frame 148. The frame 148 defines a cavity 149, which is filled with a refrigerant 150 cooled to a therapeutic temperature. For the purposes of this document, a refrigerant 150 is a material used in cold therapy, such as substances commonly used inside ice or gel packs. The shell 147 may be made of rubber, and the frame 148 may be made of metal.

Utilizing a rubber shell 147 is advantageous because the texture of the rubber ball surface 112 increases friction between the foot and the ball 106, and the ball 106 and the single channel 4, helping to improve control by preventing the ball 106 from sliding along the single channel 4 during use. Utilizing a metal frame 148 is advantageous because it increases the structural integrity of the ball 106 and helps the ball 106 withstand deformation when a user applies force to the ball 106.

In the FIG. 6, the ball surface 112 is shown in contact with the distal surface 22. The distal surface 22 has a shape that is analogous to the shape of the ball 106. In other words, when the ball 106 is in its distalmost position, a portion of the ball surface 112 fits neatly into the distal surface 22 within the area defined by the distal rim portion 28 and the common distal point 40.

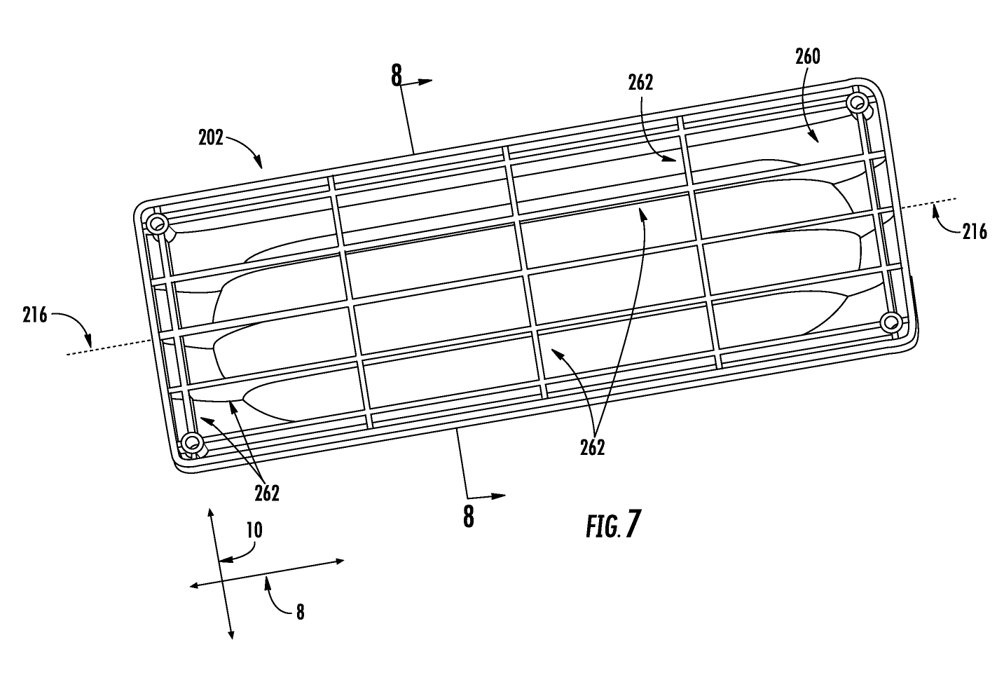

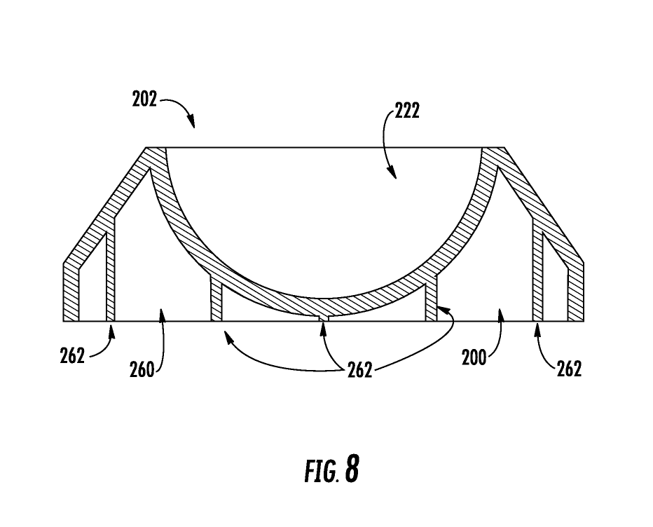

FIG. 7 is a bottom perspective view of a second embodiment of the base 202. FIG. 8 is an inverted cross sectional view of the base 202 in FIG. 7 taken along line 8-8 with a view along the longitudinal axis 216 towards the distal surface 222. In the shown embodiment, the base 202 is made by a plastic injection molding process and has a hollowed out bottom 260. Several struts 262 extend along the hollowed out bottom 260 in the longitudinal direction 8 and the lateral direction 10. The base 202 may contain two to ten struts 262. Utilizing a plastic injection molding process allows for the efficient low cost manufacture of a lightweight base 202, while the use of the struts 262 increases the strength of the base 202, thereby preventing deformation when a user applies force to the base 202 with his or her foot.

The user may perform a massage by placing the base 2, 202 on the floor or another flat surface. The user inserts the ball 6, 106 into the middle surface 20 of the single channel 4, and places the bottom of his or her foot on the ball 6. The user will then roll the ball 6 back and forth along the longitudinal axis 16 by moving his or her foot forward and backward, while applying enough pressure on the ball 6 to deeply massage the planter fascia. The device may be used in a seated or standing position. However, a user may find greater control using the device in a seated position.

The spherical shape of the ball 6 is advantageous. A spherical shape also allows for the effective treatment of variously shaped feet. In particular, the spherical shape is more effective at treating feet with high arches than a cylindrical roller.

Depending on the size of the ball 6, the spherical shape of the ball 6 also allows the user to focus treatment on a particular area. A spherical ball 6 will extend more deeply into the user's tissue at a particular location than a cylindrical roller. The ball 6 ideally has a diameter of between one and three inches. A ball 6 with a diameter of about two inches is particularly effective at targeting the plantar fascia.

In some instances, the user may also decide to cool the ball 6 prior to use. A method of treating plantar fasciitis involves applying a cold surface to the area of the injury for a period of time, usually between 10 and 20 minutes. This helps reduce inflammation and provides relief from pain. Accordingly, prior to use, the user may desire to cool the ball 6 to a therapeutic temperature similar to the temperature of an ice pack commonly used to treat sports injuries. This may be done by placing the ball 6 in a common household freezer.

The material used to make the ball 6 can have an impact on how effectively the ball 6 retains the therapeutic temperature. A ball 6 made of certain materials, such as granite or steel, may retain a therapeutic temperature over a longer period than a ball 6 made of other materials, such as plastic or wood. Alternatively (as shown in FIG. 6), the ball 106 may further comprise a hollow cavity 149 that holds a refrigerant 150 such as water. By incorporating the refrigerant 150, the ball 6 may retain the therapeutic temperature for a longer period of time.

During use, the shape of the middle surface 20 limits the movement of the ball 6 in the lateral direction 10. This is advantageous to the treatment of plantar fasciitis. In the absence of the middle surface 20, when the user applies pressure to the ball 6 and rolls it, the user may inadvertently cause the ball 6 to move laterally away from the area the user intends to massage. Because the middle surface 20 limits this lateral movement, the user can apply greater pressure the targeted area, thereby enabling a deeper massage. While it is desirable to limit lateral movement as much as possible, truly eliminating all lateral movement is not feasible. A single channel 4 which allows less than ⅛th of an inch of lateral movement gives the user a level of control that allows for a deep massage.

In some embodiments, such as the embodiment shown in FIG. 5, the concave arc shape 34 is a circular arc with an arc radius 50, and the ball radius 46 is up to about the circular arc radius 50. In these embodiments, the ball radius 46 is slightly less than the circular art radius 50. Ideally, the ball radius 46 would be just small enough for the ball surface 12 to contact the middle surface 20 along the longitudinal axis 16, while still allowing the ball 6 to travel freely in the longitudinal direction 8.

Preferably, the constant arc depth 38 is not greater than the ball radius 46 if the concave arc shape 34 is a circular arc. If the constant arc depth 38 is greater than the ball radius 46, the user would not be able to freely insert and remove of the ball 6 from the middle surface 20. In other words, a user would not be able to insert or remove the ball 6 from the middle surface 20 without removing a portion of the base 2.

Finally, it is advantageous for the shape of the distal surface 22 and the shape of the proximal surface 18 to be analogous to the shape of the ball 6. During use, the distal surface 22 prevents the ball 6 from further travel along the longitudinal axis 16 in the distal direction, and the proximal surface 18 prevents further travel along the longitudinal axis 16 in the proximal direction. When the distal surface 22 is analogous to the shape of the ball, the ball surface 12 fits neatly into the distal surface 22 within the area defined by the distal rim portion 28 and the common distal point 40. During use, when the ball 6 is in contact with the distal surface 22, the interaction between the ball surface 12 and the distal surface 22 occurs along the distal surface 22 in an uninterrupted fashion, causing friction between the ball surface 12 and the distal surface 22. This friction improves control and helps prevent the ball 6 from inadvertently sliding when the user applies a force to the ball 6.

Although the present invention has been described herein with reference to particular embodiments, it is to be understood that these embodiments are merely illustrative of the principles and applications of the present invention. It is, therefore, to be understood that numerous modifications may be made to the illustrative embodiments and that other arrangements may be devised without departing from the spirit and scope of the present invention.

What is claimed is:

1. A massage device comprising:
a base with a longitudinal axis and a single channel defined by a rim, the single channel is symmetrical along the longitudinal axis and has a proximal surface, a distal surface, and a middle surface;
the middle surface extends a predetermined length between the proximal surface and the distal surface, a cross section of the middle surface has a concave arc shape along the entire predetermined length, the concave arc shape has a constant arc width and a constant arc depth;
a ball with a ball surface and a ball radius;
the ball radius is substantially equal to the constant arc depth;
the ball is capable of being freely inserted into and freely removed from the single channel; and
when the ball surface makes contact with the middle surface the ball may roll in a longitudinal direction, while the concave arc shape limits the ball from rolling in a lateral direction.

2. The massage device of claim 1, wherein the constant arc depth is between 70% and 100% of the ball radius.

3. The massage device of claim 1, wherein the concave arc shape is a circular arc with an arc radius up to about the ball radius, and the concave arc depth is up to about the ball radius.

4. The massage device of claim 1, further comprising:
the rim has a proximal rim portion abutting the proximal surface and a distal rim portion abutting the distal surface, the proximal rim portion and the distal rim portion each have a concave semi-circular shape with an open side, and each open side has a semi-circle width;
the open side of the proximal rim portion, and the open side of the distal rim portion face towards the middle surface; and
the semi-circle width of the proximal rim portion and the semi-circle width of the distal rim portion are the same as the constant arc width.

5. The massage device of claim 4, further comprising:
the proximal surface extends from the proximal rim portion in a curved concave manner towards a proximal common point located along the longitudinal axis at a proximalmost edge of the middle surface; and
the distal surface extends from the distal rim portion in a curved concave manner towards a distal common point along the longitudinal axis at a distalmost edge of the middle surface.

6. The massage device of claim 5, further comprising:
the proximal surface and the distal surface have a concave shape analogous to the ball surface.

7. The massage device of claim 1, wherein the ball is made of stone.

8. The massage device of claim 1, wherein the predetermined length is between 3 inches and 12 inches.

9. The massage device of claim 1, further comprising the ball has a shell which surrounds a frame, the frame defines a cavity, and the cavity holds a refrigerant.

10. The massage device of claim 9, wherein the refrigerant is water.

11. The massage device of claim 9, wherein the shell is made of rubber and the frame is made of metal.

12. The massage device of claim 1, wherein the ball surface has been treated to increase friction.

13. The massage device of claim 1, wherein the ball radius is between 0.5″ and 1.5″.

14. A massage device comprising:
a base with a longitudinal axis and a single channel defined by a rim, the single channel is symmetrical along the longitudinal axis and has a proximal surface, a distal surface, and a middle surface;
the middle surface extends a predetermined length between the proximal surface and the distal surface, a cross section of the middle surface has a concave arc shape along the entire predetermined length, the concave arc shape has a constant arc width and a constant arc depth;
the rim has a proximal rim portion abutting the proximal surface and a distal rim portion abutting the distal surface, the proximal rim portion and the distal rim portion each have a concave semi-circular shape with an open side, and each open side has a semi-circle width;
the open side of the proximal rim portion, and the open side of the distal rim portion face towards the middle surface;
the semi-circle width of the proximal rim portion and the semi-circle width of the distal rim portion are the same as the constant arc width;
the proximal surface extends from the proximal rim portion in a curved concave manner towards a proximal common point located along the longitudinal axis at a proximalmost edge of the middle surface;
the distal surface extends from the distal rim portion in a curved concave manner towards a distal common point along the longitudinal axis at a distalmost edge of the middle surface;
a ball with a ball surface and a ball radius;
the ball radius is substantially equal to the constant arc depth;
the ball is capable of being freely inserted into and freely removed from the single channel; and
when the ball surface makes contact with the middle surface the ball may roll in a longitudinal direction, while the concave arc shape limits the ball from rolling in a lateral direction.

15. The massage device of claim 14, wherein the constant arc depth is between 70% and 100% of the ball radius.

16. The massage device of claim 14, wherein the concave arc shape is a circular arc with an arc radius up to about the ball radius, and the concave arc depth is up to about the ball radius.

17. The massage device of claim 14, wherein the ball is made of stone.

18. The massage device of claim 14, further comprising the ball has a shell which surrounds a frame, the frame defines a cavity, and the cavity holds a refrigerant.

19. The massage device of claim 18, wherein the refrigerant is water.

20. The massage device of claim 19, wherein the shell is made of rubber and the frame is made of metal.
